(19) United States
(12) Patent Application Publication
(10) Pub. No.: US 2015/0308305 A1
(43) Pub. Date: Oct. 29, 2015

(54) Preheating apparatus and method for the installation of a preheating apparatus

(71) Applicant: WEBASTO SE, Stockdorf (DE)

(72) Inventor: Magnus HERTA, Schwifting (DE)

(21) Appl. No.: 14/441,583

(22) PCT Filed: Nov. 12, 2013
(86) PCT No.: PCT/EP2013/073615

§ 371 Date: May 8, 2015

(30) Foreign Application Priority Data
Nov. 12, 2012 (DE) 10 2012 220 572.1

(51) Int. Cl. F01M 5/02; B23P 19/04; F01M 5/00

(52) U.S. Cl. CPC F01M 5/021; F01M 5/001; B23P 19/04

(57) ABSTRACT

A preheating apparatus for a vehicle having an operating fluid storage chamber of a first assembly, wherein a first operating fluid for operation in the first assembly is provided in the operating fluid storage chamber, an electric pump, wherein the electric pump is arranged in an external region of the operating fluid storage chamber and of the first assembly, and at least one heat source for supplying heat to the first operating fluid or removing heat from the first operating fluid, wherein the electric pump pumps the operating fluid out of the operating fluid storage chamber to the heat source.

The invention relates to a preheating apparatus and to a method for the installation of a preheating apparatus.

At low temperatures, operating fluids, in particular engine, transmission and hydraulic oils, have a high viscosity. Owing to the high viscosity, frictional resistances in the moving components, such as pistons in the engine, the engine transmission and the oil pump, are increased, as is the probability of air induction into the fluid circuits which are not closed, such as the oil lubrication system for the engine and the transmission. Moreover, the lubricating film for the moving components may separate.

To reduce viscosity at low temperatures, preheating systems are used, it being necessary to modify existing components, such as the oil sump, for currently known solutions.

It is therefore the object of the invention to provide a system which allows selective influencing of the viscosity or temperature of the operating fluids by simple and low-cost means.

This object is achieved by means of a preheating apparatus or a method in accordance with the independent claims.

A preheating apparatus, in particular for a vehicle, comprises an operating fluid storage chamber of a first assembly, wherein the assembly is preferably an internal combustion engine or a hydraulic motor. The first assembly can be a hydraulic pump, a hydraulic cylinder or a cooling unit. Provided in the operating fluid storage chamber is an operating fluid, which is used in the assembly. The operating fluid storage chamber can be an oil sump. However, provision can also be made for the operating fluid storage chamber to be an integral component of the first assembly. The operating fluid is preferably an oil, in particular an engine oil or a hydraulic oil. The preheating apparatus furthermore comprises an electric pump, wherein the electric pump is arranged in an external region, i.e. outside the operating fluid storage chamber and the first assembly. It is therefore advantageously unnecessary for the manufacturer of the assembly or of the operating fluid storage chamber to provide the assembly or the operating fluid storage chamber with an electric pump or to provide installation points in the design. In particular, existing systems can advantageously be retrofitted with a preheating apparatus. Moreover, the preheating apparatus has at least one heat source for supplying heat to the operating fluid or removing heat from the operating fluid, making it possible to provide a summer mode or a winter mode and enabling the viscosity of the operating fluid to be adapted accordingly. Provision can also be made for the use of an existing heat source. In this case, the electric pump pumps the operating fluid out of the operating fluid storage chamber to the heat source. An additional fluid connection that can be fitted easily to the existing fluid lines is thus provided between the operating fluid storage chamber and the heat source.

Provision can be made for the heat source to comprise a heat exchanger, an electric or fuel-operated parking heater and/or a vehicle cooling unit. Provision can furthermore be made for a first fluid circuit to pass through the heat exchanger, wherein the first fluid circuit opens into and out of the operating fluid storage chamber. Provision can furthermore be made for a second fluid circuit to pass through the heat exchanger, said fluid circuit preferably passing through a parking heater or a vehicle cooling unit or the parking heater and the vehicle cooling unit. Provision can furthermore be made for controllable valves to prevent inflow to one or all of the heat sources. Provision is preferably made for the heat source to comprise a heat transfer zone. The heat transfer zone can be a plate which transfers heat. The heat transfer zone can be two or more adjoining fluid line segments of a first and a second fluid connection, said segments carrying the first and the second fluid.

Provision can be made for the heat source to comprise a second fluid line, which is filled with a second operating fluid, wherein the second operating fluid is in heat-exchanging connection with the first operating fluid. Provision can be made for a first fluid connection carrying the first operating fluid to be provided between the assembly and the operating fluid storage chamber, and wherein the first fluid connection and the second fluid connection are arranged in a bundled manner, at least in one segment, thus allowing heat transfer between the first operating fluid and the second operating fluid.

If the heat source comprises the heat exchanger, provision can be made for a second operating fluid to flow through the heat exchanger for heat supply or for heat removal to the first or from the first operating fluid, wherein the second operating fluid preferably comes from a second assembly. The second assembly can preferably be the parking heater or the vehicle cooling unit. Provision can be made for the second operating fluid to be a liquid or a gas, wherein the second operating fluid is preferably a cooling liquid and preferably comprises glycol. In particular, provision can be made for the heat exchanger to be an already existing heat exchanger, with the result that an advantageous heat source is advantageously provided. Provision can be made for the engine itself to serve as a heat source, wherein the engine is advantageously preheated by a parking heater. Provision can be made for the heat exchanger to be a plate heat exchanger, in particular a coolant/oil heat exchanger, wherein, in particular, provision can be made for the heat exchanger to be connected to the engine, thus ensuring that cooling of the first operating fluid, in particular of the engine oil, is achieved in a normal mode and heating of the first operating fluid is achieved in a parking heater mode. It is self-evident that coolant/oil heat exchangers already installed in the vehicle can also be used as a heat source.

Provision can be made for the heat source to be arranged in an external region of the operating fluid storage chamber and of the first assembly. It is thereby advantageously achieved that the heat source, e.g. the heat exchanger, can be arranged in the external region independently of a given design of the operating fluid storage chamber and/or of the first assembly.

The operating fluid storage chamber generally has at least one solid drainage means, in particular a solid drain screw, which closes at least one drain opening. Provision can preferably be made to provide at least one drainage means having a hollow channel, in particular a drain screw having a hollow channel, instead of the solid drain screw. Provision can also be made for the drainage means to be a hollow conical screw. Provision can also be made for a pipe connection or bulkhead union to be provided instead of or in addition to the drainage means. A total of at least two hollow channels are preferably provided in the at least one drainage means, in particular in the at least one drain screw. Provision can furthermore be made for each of the hollow channels to be in fluid communication with the heat source. A simple-to-install preheating apparatus, which can furthermore advantageously achieve direct heating or cooling of the first operating fluid, is thereby created. Provision can furthermore be made for at least two of the hollow channels in each case to be connected to a hose in the operating fluid storage chamber, wherein the hose is preferably an annular hose. It is thereby advantageously ensured that a second operating fluid, preferably a cooling liquid, can flow through the hose in order in this way to achieve heat supply or heat removal by the second operating fluid to or from the first operating fluid. The electric pump preferably pumps the second operating fluid from the heat source, preferably the parking heater or the vehicle cooling unit, through the hose in the operating fluid storage chamber. The hose can advantageously be passed through the existing openings, thus avoiding removal of the operating fluid chamber. Provision can also be made to connect a tube to the hollow channels in the operating fluid chamber, wherein in this way heat transfer from a second operating fluid circulating in the tube to the first operating fluid is increased by virtue of the smooth surface of the tube.

The first operating fluid is preferably pumped through the hollow channels to the heat exchanger by the electric pump.

In a preferred embodiment, fastening fixtures are provided in the external region, wherein the electric pump and/or the heat source have/has fastening devices for fastening in the external region, preferably to the fastening fixtures. In a preferred embodiment, the fastening devices can be fastened detachably to the fastening fixtures or in the external region. Provision can be made for the fastening fixtures or the fastening devices to be matched to an outer contour of the assembly or of the operating fluid storage chamber, thus advantageously making possible flush fitting of the electric pump or of the heat source.

An advantageous method for the installation of a preheating apparatus on a first assembly having an operating fluid storage chamber comprises the following steps: fastening an electric pump in an external region of the assembly, fastening a heat source in the external region of the assembly and connecting the electric pump to the assembly and to the heat source by means of a fluid connection. A method which allows simple mounting of a preheating apparatus on an existing assembly having an operating fluid storage chamber is thereby advantageously made available.

The operating fluid storage chamber preferably has at least one opening to the external region, wherein the method comprises the following step: insertion of at least one screw having a total of at least two hollow channels into the at least one opening. This creates a simple way of bringing about the fluid connection between the assembly and the heat source or the operating fluid storage chamber and the heat source without making a change in the existing apparatus, e.g. by drilling an additional opening.

The at least two hollow channels are preferably connected by a hose arranged in the storage chamber, thus creating a possibility for pumping a second operating fluid with a temperature that differs from the first operating fluid through the hose, thus making it possible to accomplish heat supply or heat removal from the first operating fluid to the second operating fluid. Provision can be made for the hose to be introduced through the opening into the operating fluid storage chamber.

A temperature sensor or a bimetallic switch is preferably provided, allowing the preheating apparatus to be controlled in a temperature-dependent manner, in particular by means of a control unit. The temperature sensor or the digital switch is preferably situated in an interior of the operating fluid storage chamber. Provision can also be made to arrange a multiplicity of temperature sensors or bimetallic switches in the operating fluid storage chamber.

As an alternative or supplementary measure, provision can be made for a warm exhaust gas from the heat source to be directed to the operating fluid storage chamber in order to additionally heat the operating fluid. In this case, the exhaust gas can be directed pointwise toward one or more locations of a bottom of the operating fluid storage chamber or can be directed over an extended area onto the bottom of the operating fluid storage chamber by means of a plate arranged under the operating fluid storage chamber. It is also possible to use an additional fresh air heater instead of the existing heat source, such as the parking heater, in order to produce a warm exhaust gas stream and direct it onto the bottom of the operating fluid storage chamber.

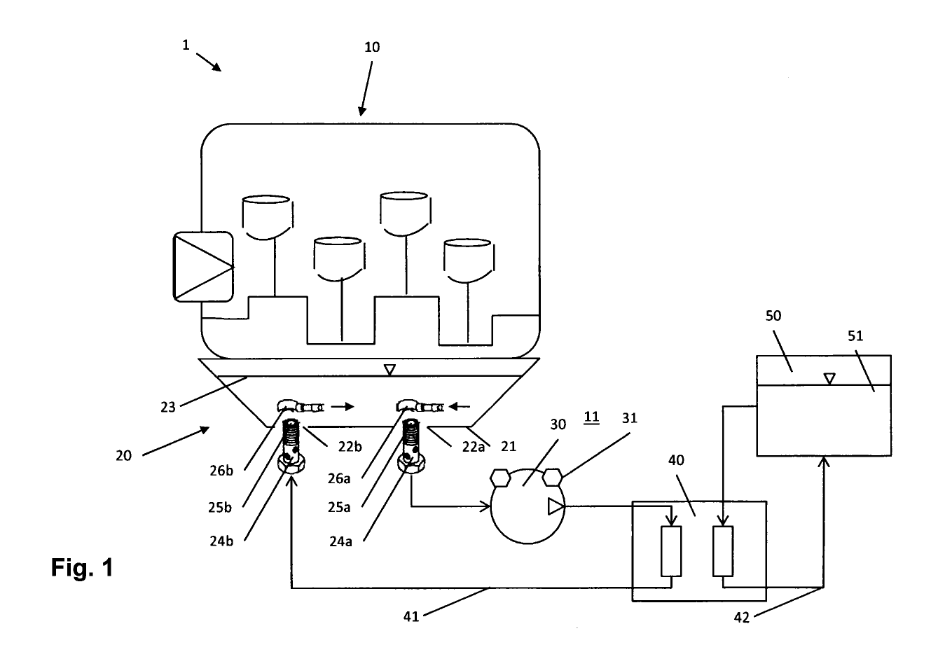

FIG. 1 shows a first illustrative embodiment of a preheating apparatus according to the invention;

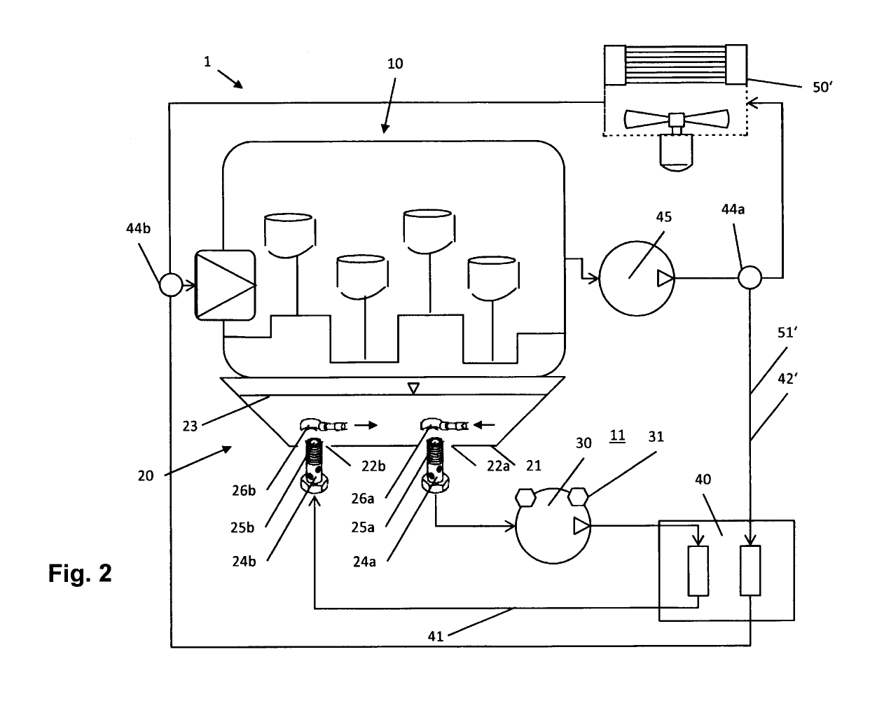

FIG. 2 shows a second illustrative embodiment of a preheating apparatus according to the invention;

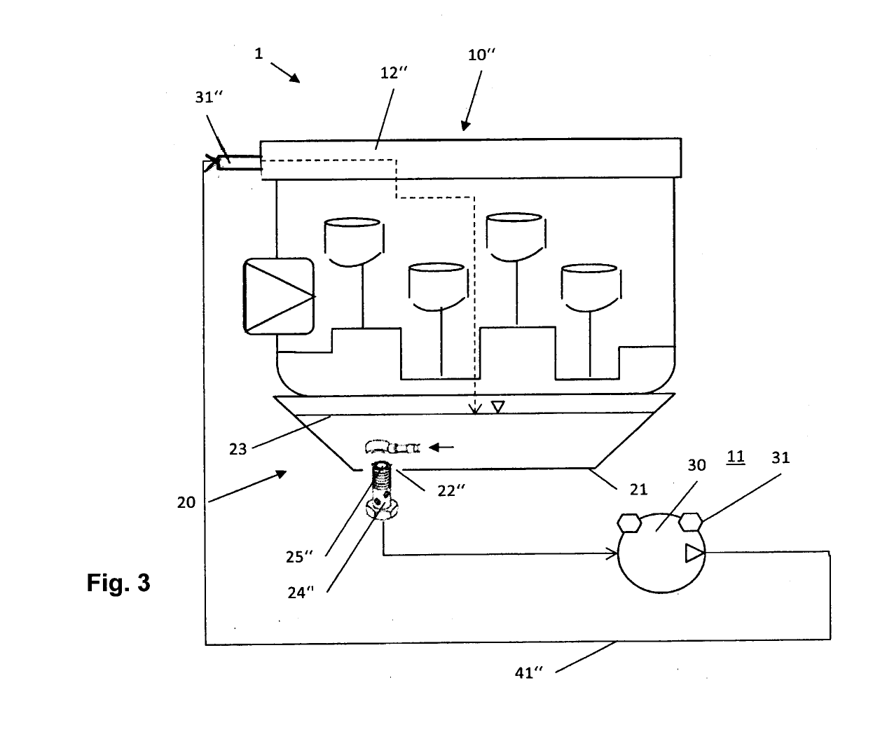

FIG. 3 shows a third illustrative embodiment of a preheating apparatus according to the invention;

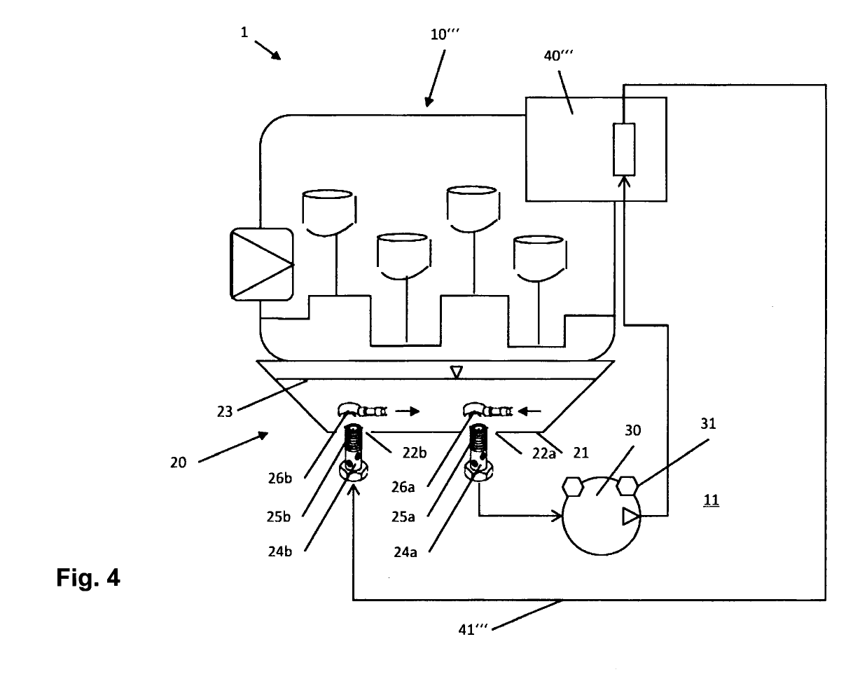

FIG. 4 shows a fourth illustrative embodiment of a preheating apparatus according to the invention; and

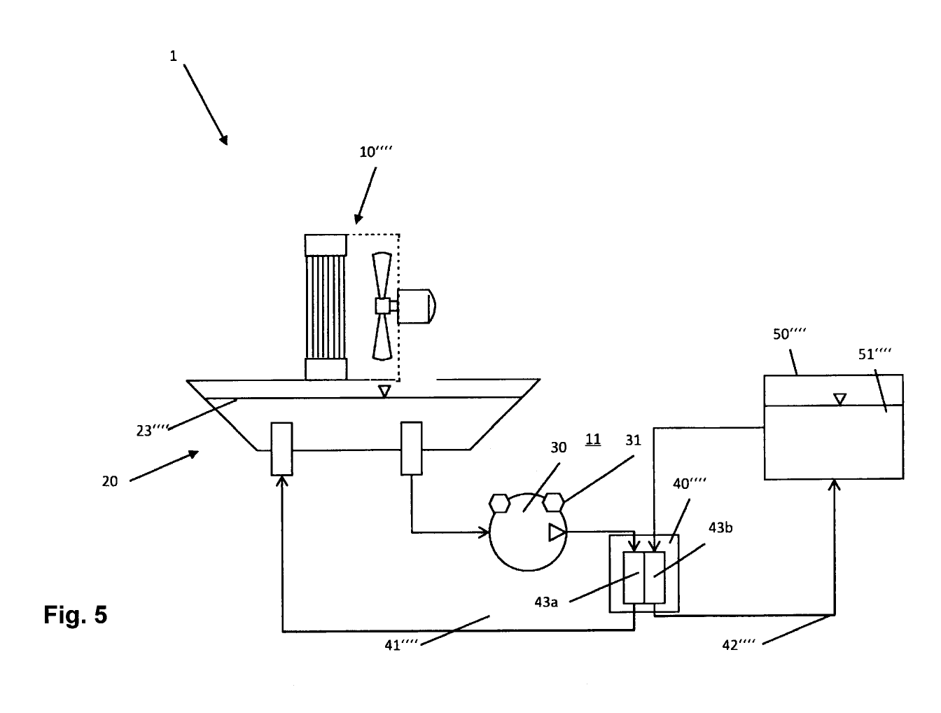

FIG. 5 shows a fifth illustrative embodiment of a preheating apparatus according to the invention.

In the following description of the drawings, identical reference signs denote the same or comparable components.

FIG. 1 shows a preheating apparatus 1, which comprises a first assembly 10 having an operating fluid storage chamber 20. The operating fluid storage chamber 20 is arranged in a lower region of the first assembly 10. However, provision can also be made for the operating fluid storage chamber to be arranged on one side or above the assembly 10.

Provided in a bottom 21 of the operating fluid storage chamber 20 are two openings 22a, 22b, which are generally closed by oil drain screws (not shown), allowing an operating fluid 23 in the operating fluid storage chamber 20 to be drained from the operating fluid storage chamber 20 in a simple manner. Provision is made for the oil drain screws to be replaced by drain screws 24a, 24b provided with hollow channels 25a, 25b and to insert them into the openings 22a, 22b. Attachments 26a, 26b are arranged on the ends of the drain screws 24a, 24b, which project into the operating fluid storage chamber 20, wherein provision can be made for the attachments 26a, 26b—or indeed for the drain screws themselves—to have a constricted inflow channel. Air induction and hence bubble formation is thereby advantageously avoided. It is self-evident that it is possible not only for drain screws to be inserted into the openings 22a, 22b in the bottom 21 but also for other openings, e.g. openings present in an upper region of the operating fluid storage chamber, into which openings inlet screws are generally inserted, to be used. Provision can also be made for corresponding pins or other devices with hollow channels to be provided instead of drain screws.

In this arrangement, the first drain screw 24a is connected by a fluid connection to an electric pump 30, which is arranged in an external region 11 of the assembly and of the operating fluid storage chamber 20, allowing the electric pump 30 to pump the operating fluid 23 through the hollow channel 24a on the suction side. The electric pump is fastened in the external region 11 by fastening devices 31. Arranged on the discharge side of the electric pump 30 is a heat exchanger 40, through which the operating fluid 23 is pumped to the second drain screw 24b and the hollow channel 25b thereof by the electric pump 30, and therefore overall a first operating fluid circuit 41 is formed.

A second operating fluid 51 of a second assembly 50 flows through the heat exchanger 40 in a second operating fluid circuit 42. Provision can be made for the second assembly 50 to heat the second operating fluid 51 to a higher temperature than the first operating fluid 23, with the result that heat transfer from the second operating fluid 51 to the first operating fluid 23 takes place in the heat exchanger 40. The heat exchanger 40 and the second assembly 50 serve as a heat source 40, 50 for the first operating fluid 23, wherein the first operating fluid 23 can absorb heat from the heat source. As a result, the temperature of the first operating fluid 23 in the first fluid circuit 41 is increased, wherein the first operating fluid 41 pumped into the operating fluid storage chamber 20 increases the overall temperature of the first operating fluid 23 in the operating fluid storage chamber 20. In this way, a preheating apparatus 1 suitable for cold regions is advantageously created in a simple manner. Provision can also be made for the first operating fluid 23 to release heat to the heat source or the second operating fluid 51 when the first operating fluid 23 has a higher temperature than the second operating fluid 51.

FIG. 2 shows an illustrative embodiment similar to FIG. 1, wherein a second operating fluid circuit 42′ is connected to a cooling circuit 43 of a vehicle cooling unit 50′, wherein a second operating fluid 51′ is a cooling liquid. The cooling circuit 43 passes through the first assembly 10, which is designed as an internal combustion engine 10, and the vehicle cooling unit 50′.

The second operating fluid circuit 42′ is preferably connected by opening the existing cooling circuit 43 at two points, inserting at least two branch elements 44a, 44b at the opened points and connecting the second operating fluid circuit 42′. Provision can also be made for a first connection element 44a to be arranged ahead of and/or after the vehicle cooling unit 50′, as viewed in the direction of flow, wherein provision can be made for a controller to switch between a heating mode and a cooling mode by means of valves (not shown) inserted into the lines.

Arranged in the cooling circuit, there is preferably a second electric or fuel-operated pump 45, which pumps the coolant in the second operating fluid circuit 42′ and/or the cooling circuit 43. It is self-evident that a second electric pump 45 can also be arranged in the second operating fluid circuit and there pump the second operating fluid in the illustrative embodiment shown in FIG. 1.

The first operating fluid circuit 41, which is shown in FIG. 2, is constructed in the same way as in the first illustrative embodiment, wherein the first operating fluid 23 is pumped out of the operating fluid storage chamber 20 to the heat exchanger 40 by an electric pump 30.

FIG. 3 shows a first assembly 10″ designed as an internal combustion engine and having a cylinder head cover 12″, which has a vent line (not shown). A check valve 31″ is inserted into the vent line, wherein the check valve 31″ is connected to a first operating fluid circuit 41″.

Provision is made here for a drain screw 24″ having a hollow channel 25″ to be arranged in an opening 22″ in the bottom 21 of the operating fluid storage chamber 20. Connected to the drain screw is a fluid line which forms a fluid connection to the electric pump 30 on the suction side. Arranged on the discharge side is a fluid line 41″ leading to the check valve 31″, thus allowing the electric pump to pump the operating fluid 23 out of the operating fluid storage chamber, via the fluid line 41″, through the check valve 31″, into the cylinder head cover 12″ and thus into an upper region of the first assembly 10″. The operating fluid pumped into the upper region of the first assembly 10″ is warmed by the waste heat from the moving cylinders and flows back into the operating fluid storage chamber through the first assembly 10″. A preheating apparatus 1″ which uses the heat of the first assembly 10″ itself to heat the operating fluid is thus created. Moreover, the existing connection possibilities are used in a simple manner.

FIG. 4 shows an illustrative embodiment similar to FIG. 1, wherein the heat exchanger 40′″ is arranged on a first assembly 10′″ and no second operating fluid preferably flows through the heat exchanger for heat transfer; instead, the first assembly 10′″ is used as a heat source or heat sink in the heat exchanger. The heat exchanger is designed as a plate heat exchanger. If the assembly 10′″ is preheated by a parking heater, excess heat can be released to the first operating fluid 23 via the heat exchanger 40′″. In this arrangement, a fluid line 41′″ leads from the heat exchanger 40′″ to the operating fluid storage chamber 20. Provision can be made for the electric pump 30 to pump the first operating fluid 23 out of the operating fluid storage chamber 20 to the heat exchanger 40′″.

FIG. 5 shows an assembly 10″″ designed as a cooling unit, wherein the first operating fluid 23″″ is a coolant and can be pumped out of the operating fluid storage chamber 20 by an electric pump 30 via a first fluid line 41″−. A second assembly 50″″, e.g. a motor vehicle engine, has a second operating fluid 51″″, wherein the second operating fluid can be pumped out of the second assembly 50″″ via a second fluid line 42″″. Provision can also be made for the second operating fluid to flow off into a second operating fluid storage chamber of the second assembly through the second fluid line 42″″ or for the second operating fluid to be pumped to the second operating fluid storage chamber.

The electric pump 30 pumps the first fluid 23″″ to the heat source, which comprises a heat transfer zone 40″″, wherein the heat transfer zone is formed by two fluid line segments 43a, 43b of the first fluid line 41″″ and of the second fluid line 42″″, which are arranged one above the other, and wherein the heat transfer zone 40″″ acts as a heat exchanger. It is self-evident that the fluid line segments 43a, 43b can also be connected to one another by way of connecting means of good thermal conductivity instead of resting directly upon one another. In this case, the connecting means can preferably be holders, preferably consisting of copper, surrounding two fluid line segments 43a, 43b. The fluid line segments 43a, 43b can be surrounded by insulation consisting of material impermeable to heat. The fluid line segments 43a, 43b, i.e. a first fluid line segment 43a of the first fluid line 41″″ and a second fluid line segment 43b of the second fluid line 43b, are shown schematically as adjacent to one another in FIG. 5, wherein the fluid line segments 43a, 43b can be arranged parallel to one another, intertwined and/or crossing one another. Provision can also be made for a plurality of first fluid line segments 43a and/or a plurality of fluid line segments 43b to be provided, wherein, in particular, one first fluid line segment 43a in a pair with a second fluid line segment 43b in each case form a heat transfer zone, with the result that a plurality of heat transfer zones is formed overall.

The features of the invention which are disclosed in the above description, in the drawings and in the claims may be essential to the implementation of the invention either individually or in any combination.

### LIST OF REFERENCE SIGNS

1 preheating apparatus
10 first assembly
10″ first assembly
10″″ first assembly
11 external region
12″ cylinder cover
20 operating fluid storage chamber
21 bottom of the operating fluid storage chamber
22a opening
22b opening
22″ opening
23 first operating fluid
23″″ first operating fluid
24a drain screw
24b drain screw
24″ drain screw
25a hollow channel
25b hollow channel
25″ hollow channel
26a attachment
26b attachment
30 electric pump
31 fastening device
40 heat exchanger
40′″ heat exchanger
40″″ heat transfer zone
41 first operating fluid circuit
41′ first operating fluid circuit
41″ fluid line
41′″ fluid line
41″″ first fluid line
42 second operating fluid circuit
42′ second operating fluid circuit
42″″ second fluid line
43 cooling circuit
43a first fluid line segment
43b second fluid line segment
44a connection element
44b connection element
45 second electric pump
50 second assembly
50′ vehicle cooling unit
50″″ second assembly
51 second operating fluid
51′ second operating fluid
51″″ second operating fluid

1. A preheating apparatus for a vehicle, comprising
an operating fluid storage chamber of a first assembly, wherein a first operating fluid for operation in the first assembly is provided in the operating fluid storage chamber,
an electric pump,
wherein the electric pump is arranged in an external region of the operating fluid storage chamber and of the first assembly, and
at least one heat source for supplying heat to the first operating fluid or removing heat from the first operating fluid,
wherein the electric pump conveys the first operating fluid out of the operating fluid storage chamber to the heat source.

2. The preheating apparatus as claimed in claim 1, wherein the heat source comprises a heat exchanger and/or a parking heater and/or a vehicle cooling unit.

3. The preheating apparatus as claimed in claim 1, wherein the heat source comprises a second fluid line, which is filled with a second operating fluid that exchanges heat with the first operating fluid.

4. The preheating apparatus as claimed in claim 3, wherein a first fluid line carrying the first operating fluid is provided between the assembly and the operating fluid storage chamber, and wherein the first fluid line and the second fluid line are arranged in a bundled manner, at least in one segment, thus allowing heat transfer between the first operating fluid and the second operating fluid.

5. The preheating apparatus as claimed in claim 1, wherein a second operating fluid flows through the heat source for heat supply or for heat removal and wherein the second operating fluid comes from a second assembly.

6. The preheating apparatus as claimed in claim 5, wherein the second operating fluid is a heat transfer medium, preferably a liquid heat transfer medium.

7. The preheating apparatus as claimed in claim 1, wherein the heat source is arranged in an external region of the operating fluid storage chamber.

8. The preheating apparatus as claimed in claim 1, wherein the operating fluid storage chamber has at least one drainage means, wherein the at least one drainage means has at least one hollow channel.

9. The preheating apparatus as claimed in claim 8, wherein the drainage means as a total of at least two hollow channels and in each case at least two of the hollow channels are connected by a hose in the operating fluid storage chamber.

10. The preheating apparatus as claimed in claim 1, wherein the electric pump and/or the heat source have/has fastening devices for fastening in the external region of the operating fluid storage chamber.

11. A method for installing a preheating apparatus on a first assembly having an operating fluid storage chamber, wherein a heat source is provided, the method comprising the following steps:
fastening an electric pump in an external region of the assembly, and
connecting the electric pump to the assembly and to the heat source by means of a fluid connection.

12. The method for installing the preheating apparatus as claimed in claim 11, wherein the operating fluid storage chamber has at least one opening to the external region, the method comprising the following step: inserting at least one screw having at least one hollow channel into the at least one opening, and connecting the at least one hollow channel to the electric pump.

13. The preheating apparatus as claimed in claim 8, wherein the at least one drainage means is a drain screw, and wherein the drain screw has at least two hollow channels.
